(19) United States
(12) Patent Application Publication
(10) Pub. No.: US 2022/0056651 A1
(43) Pub. Date: Feb. 24, 2022

(54) CHILD SAFETY DOOR BARRIER

(71) Applicant: Zhanpeng Liang, Guangzhou (CN)

(72) Inventor: Zhanpeng Liang, Guangzhou (CN)

(21) Appl. No.: 17/026,357

(22) Filed: Sep. 21, 2020

(30) Foreign Application Priority Data
Aug. 21, 2020 (CN) 202021759465.2

(51) Int. Cl. E01F 13/02; E06B 9/08

(52) U.S. Cl. CPC E01F 13/028; E06B 2009/002; E06B 9/08

(57) ABSTRACT

The present disclosure provides a child safety door barrier, including a coiled tube and a fabric wound around the coiled tube. A first mounting mechanism is disposed on a first end of the coiled tube. A second mounting mechanism is disposed on a second end opposite to the first end of the coiled tube. A circular groove is disposed inside the coiled tube. An elastic component is disposed inside the circular groove, A first end of the elastic component penetrates through the coiled tube and then fixedly connects with a first end of the fabric, a second end opposite to the first end of the elastic component is fixedly connected with the second mounting mechanism. A transceiving mechanism is disposed on a second end opposite to the first end of the fabric, and the transceiving mechanism is configured to pull the fabric out from the coiled tube and fix the fabric.

### TECHNICAL FIELD

The present disclosure relates to a technical field of household articles, and in particular to a child safety door barrier.

### BACKGROUND

In daily life, in order to prevent children from getting hurt when adults are not by their sides, there are some areas in houses that do not allow children to enter freely, such as the kitchen, bathroom, stair, balcony, etc. In order to limit an activity range of children, blocking devices, such as door barriers are usually disposed on the areas mentioned above.

However, in order to better limit the activity range of the children, the present door barriers are relatively tedious in operation. Although the door barriers are prevented from being opened by the children, it still inconvenient for the adults to operate.

### SUMMARY

In order to overcome defects existing in the prior art, an object of the present disclosure is to provide a child safety door barrier, which may be installed at positions such as where a door, a passage, and a stair opening at in houses. The child safety door limits an activity range of children and is also convenient for adults to open or close.

The object of the present disclosure above is achieved by following technical solutions.

The present disclosure provides a child safety door barrier, including a coiled tube and a fabric wound around the coiled tube. A first mounting mechanism is disposed on a first end of the coiled tube. A second mounting mechanism is disposed on a second end opposite to the first end of the coiled tube. A circular groove is disposed inside the coiled tube. An elastic component is disposed inside the circular groove. A first end of the elastic component penetrates through the coiled tube and then fixedly connects with a first end of the fabric, a second end opposite to the first end of the elastic component is fixedly connected with the second mounting mechanism. A transceiving mechanism is disposed on a second end opposite to the first end of the fabric, and the transceiving mechanism is configured to pull the fabric out from the coiled tube and fix the fabric. A locking mechanism is disposed inside the first mounting mechanism, the locking mechanism is configured to lock or unlock the coiled tube, and the locking mechanism is connected with the coiled tube.

Furthermore, the first mounting mechanism includes a first retaining ring, a first mounting base, and a first mounting cover. A first mounting hole is disposed on the first mounting base. A first end of the first retaining ring is clamped with the first end of the coiled tube, and a second end opposite to the first end of the first retaining ring is clamped with the first mounting cover. The first mounting base is clamped with a bottom of the first mounting cover, and the locking mechanism is disposed. inside the first mounting cover.

Furthermore, the locking mechanism includes a knob, a gear, a rotating spring, and a locking assembly. The locking assembly is disposed inside the first mounting cover. A gear groove is disposed on the first end of the coiled tube. The gear is clamped inside the gear groove. A first end of the rotating spring is connected with an axis of the gear, and a second end opposite to the first end of the rotating spring is connected with the knob. A bump is disposed on the knob. When the coiled tube is locked, the pump is separated from the locking assembly, and the locking assembly is clamped with gear teeth of the gear. When the coiled tube is unlocked, the bump is clamped with locking assembly, and the locking assembly is separated from the gear teeth of the gear.

Furthermore, the locking assembly includes at least one locking block and at least one stop spring. At least one first fixing column and at least one second fixing column are disposed inside the first mounting cover. The stop spring is fixed on the first fixing column. A first end of the locking block is fixed on the second fixing column. A first end of the stop spring is connected with the first mounting cover. A second end opposite to the first end of the stop spring is connected with a second end opposite to the first end of the locking block. When the coiled tube is locked, the pump is separated from the locking block, and the locking block is clamped with the gear teeth of the gear. When the coiled tube is unlocked, the bump is clamped with locking block, and the locking block is separated from the gear teeth of the gear.

Furthermore, the locking mechanism further includes a knob cover. The knob cover is clamped with the first mounting cover. A through hole is disposed on the knob cover. The knob is disposed inside the through hole. A mark is disposed on the knob cover, and the mark is configured to show whether the knob is locked or unlocked.

Furthermore, the second mechanism includes a second retaining ring, a second mounting base, and a second mounting cover. A second mounting hole is disposed on the second mounting base. A first end of the second retaining ring is clamped with the second end opposite to the first end of the coiled tube, and a second end opposite to the first end of the second retaining ring is clamped with the second mounting cover. The second mounting base is clamped with a bottom of the second mounting cover, and the second end opposite to the first end of the elastic component is fixedly connected with the second mounting cover.

Furthermore, the transceiving mechanism includes a handle rod, a first transceiving component, and a second transceiving component. The handle rod is disposed on the second end opposite to the first end of the fabric. The first transceiving component is disposed a first end of the handle rod, and the second transceiving component is disposed on a second end opposite to the first end of the handle rod.

Furthermore, the first transceiving component includes a first hook base and a first handle hook. The first handle hook is disposed on the first end of the handle rod. A first limiting block is disposed on the first hook base, and the first limiting block is configured to clamp with the first handle hook. A first fixing hole is disposed on the first hook base.

Furthermore, the second transceiving component includes a second hook base and a second handle hook. The second handle hook is disposed on the second end opposite to the first end of the handle rod. A second limiting block is disposed on the second hook base, and the second limiting block is configured to clamp with the second handle hook. A second fixing hole is disposed on the second hook base.

Furthermore, a separate assembly is disposed inside the first mounting cover, and the separate assembly is configured to separate the first mounting base and the first mounting cover. The separate assembly includes a key, a separate component, and a key spring. The key is clamped with the separate component. A first end of the key spring is connected with the first mounting base, and a second end opposite to the first end of the key spring is connected with the separate component. A push block is disposed on the separate component. When the key spring is in an original state, the push block is separated from the first mounting base, and the first mounting base is clamped with the first mounting cover. When the key spring is in a pressed state, the push block is clamped with the first mounting base, and the first mounting base is separated from the first mounting cover.

The present disclosure provides the child safety door barrier, which fixes the coiled tube in the positions where the door, the passage, the stair opening and the like at through the first mounting mechanism and the second mounting mechanism. The transceiving mechanism pulls the fabric out from the coiled tube and fix the fabric, the fabric shields and isolates the positions where the door, the passage, the stair opening and the like at, so that the activity range of the children is better limited. When the fabric is fixed in a required position, rotation of the coiled tube is limited through the locking mechanism in the first mounting mechanism, so that rotation of the fabric is limited and the fabric cannot be contracted, thus, the child safety door barrier plays a role in shielding and isolating. Driven by an elastic action of the elastic component, the fabric is always in a retracting state, so that the fabric cannot extend outwards, which prevents possibility that the fabric falls off due to a fact that fabric materials are extensible appearing in a greatest extent, thus, safety performance of the child safety door barrier is stronger.

### BRIEF DESCRIPTION OF DRAWINGS

FIG. 1 is a structural schematic diagram of a child safety door barrier of the present disclosure.

FIG. 2 is a structural schematic diagram of a first mounting mechanism and a second mounting mechanism of the present disclosure.

FIG. 3 is a structural schematic diagram of a first mounting base and a first mounting cover of the present disclosure.

FIG. 4 is a structural schematic diagram of a second mounting base and a second mounting cover of the present disclosure.

FIG. 5 is a schematic diagram of a position relationship between the second mounting mechanism and an elastic component of the present disclosure.

FIG. 6 is an enlarged schematic diagram of portion A shown in FIG. 5.

FIG. 7 is an exploded schematic diagram of a locking mechanism and a separate assembly of the present disclosure,

FIG. 8 is a structural schematic diagram the locking mechanism and the separate assembly of the present disclosure.

In the drawings; 1. coiled tube; 2. fabric; 3. first mounting mechanism; 31, first retaining ring; 32. first mounting base; 33. first mounting cover; 4. second mounting mechanism; 41. second retaining ring; 42. second mounting base; 43. second mounting cover; 5. circular groove; 6. elastic component; 7. locking mechanism; 71. knob; 72. gear; 73. rotating spring; 74. locking assembly; 741. locking block; 742. stop spring; 75. knob cover; 8, transceiving mechanism; 81. handle rod; 82. first transceiving component; 821. first hook base; 822. first handle hook; 83. second transceiving component; 831. second hook base; 832. second handle hook; 9. gear groove; 10. pump; 11, first column; 12. mark; 13, first fixing hole; 14. second fixing hole; 15. separate assembly; 151. key; 152. separate component; 153. key spring; 16. push block; 17. support rod; 18. opening; 19. first mounting hole; 20. second mounting hole; 21. second fixing column; 22. through hole; 23. first limiting block; 24. second limiting block.

### DETAILED DESCRIPTION

In order to make objects, technical solutions, and advantages of the present disclosure more clearly, a further detailed description of the present disclosure is provided below in conjunction with the accompanying drawings and embodiments. It should be understood that the specific embodiments described herein are for illustrative purposes only and are not intended to limit the present disclosure.

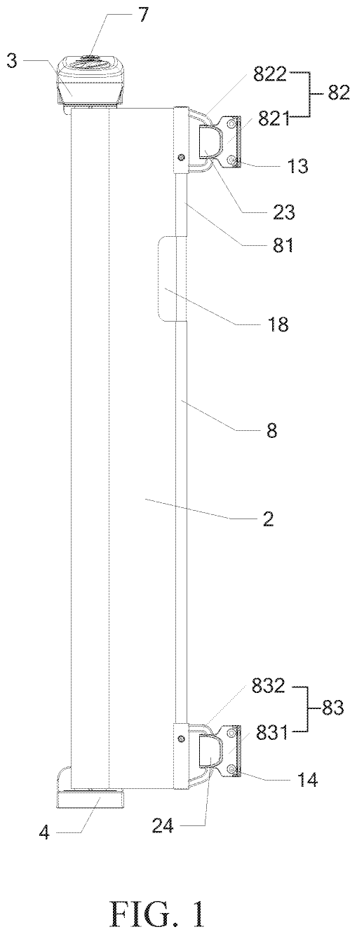

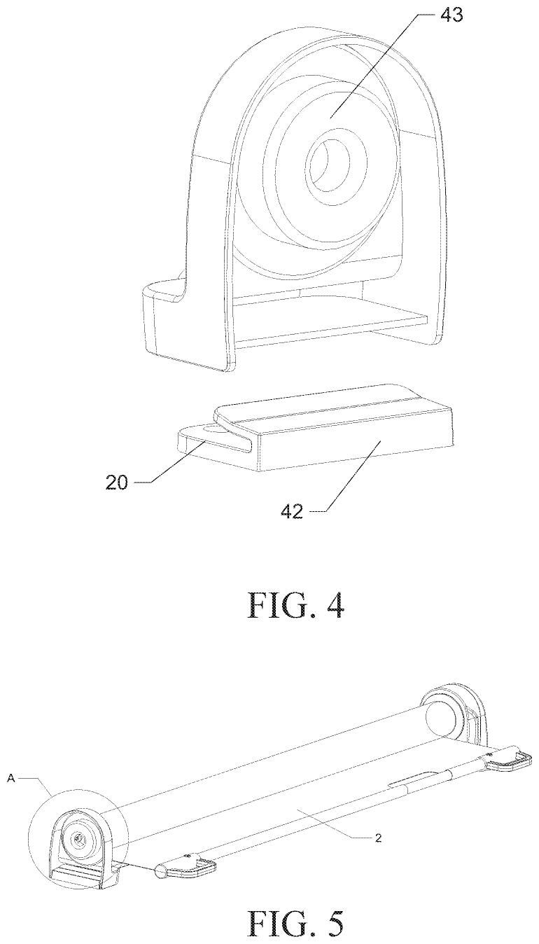

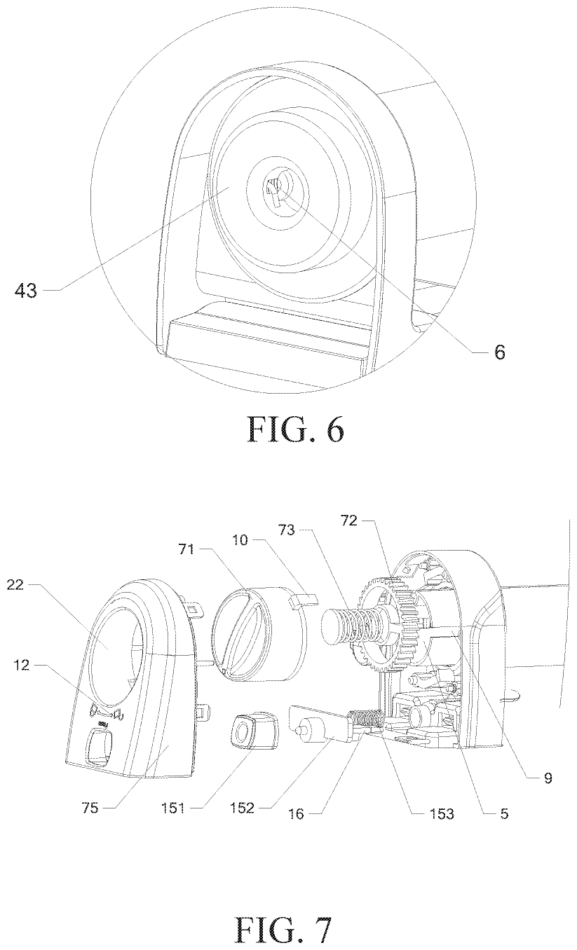

As shown in FIGS. 1-4, the present disclosure provides a child safety door barrier, including a coiled tube 1 and a fabric 2 wound around the coiled tube 1. A first mounting mechanism 3 is disposed on a first end of the coiled tube 1. A second mounting mechanism 4 is disposed on a second end opposite to the first end of the coiled tube 1. A circular groove 5 is disposed inside the coiled tube 1. An elastic component 6 is disposed inside the circular groove 1. A first end of the elastic component 6 penetrates through the coiled tube 1 and then fixedly connects with a first end of the fabric 2, a second end opposite to the first end of the elastic component 6 is fixedly connected with the second mounting mechanism 4. A transceiving mechanism 8 is disposed on a second end opposite to the first end of the fabric 2, and the transceiving mechanism 8 is configured to pull the fabric 2 out from the coiled tube 1 and fix the fabric 2. A locking mechanism 7 is disposed inside the first mounting mechanism 3, the locking mechanism 7 is configured to lock or unlock the coiled tube 1, and the locking mechanism 7 is connected with the coiled tube 1.

The child safety door barrier fixes the coiled tube 1 in the positions where the door, the passage, the stair opening and the like which are with high safety hazards at through the first mounting mechanism 3 and the second mounting mechanism 4. The transceiving mechanism 8 pulls the fabric 2 out from the coiled tube 1 and fixes the fabric 2, the fabric 2 shields and isolates the positions where the door, the passage, the stair opening and the like at, so that an activity range of children is better limited.

The elastic component 6 is a spring.

When the fabric 2 is fixed in a required position, the locking mechanism 7 in the first mounting mechanism 3 is rotated to a locked state, at this time, rotation of the coiled tube 1 is limited through the locking mechanism 7 in the first mounting mechanism 3, so that rotation of the fabric 2 is limited and the fabric 2 cannot be contracted, thus, the child safety door barrier plays a role in shielding and isolating. Driven by an elastic action of the elastic component 6, the fabric 2 is always in a retracting state, so that the fabric 2 cannot extend outwards, which prevents possibility that the fabric 2 falls off due to a fact that fabric materials are extensible appearing in a greatest extent, thus, safety performance of the child safety door barrier is stronger.

When the fabric 2 needs to be retracted, the locking mechanism 7 is switched from the locked state to an unlocked state, and the fabric 2 is not further fixed by the transceiving mechanism 8. At this time, the rotation of the coiled tube 1 and the fabric 2 is not further limited by the locking mechanism 7, driven by the elastic action of the elastic component 6 itself, the fabric 2 automatically retracts. For adults, operations of opening or closing the child safety door barrier are more convenient, time consuming, and labor saving.

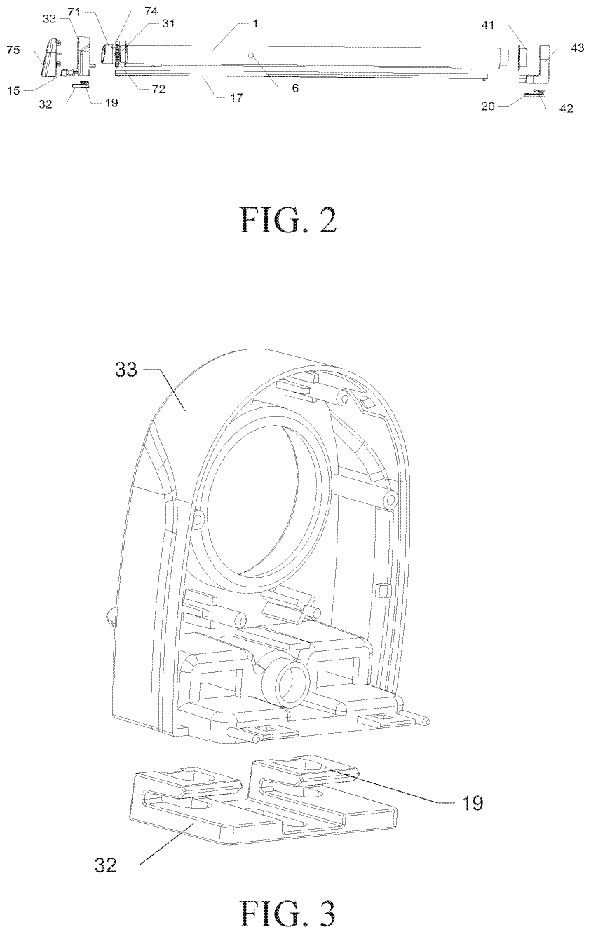

As shown in FIGS. 2-3, the first mounting mechanism 3 includes a first retaining ring 31, a first mounting base 32, and a first mounting cover 33. A first mounting hole 19 is disposed on the first mounting base 32. A first end of the first retaining ring 31 is clamped with the first end of the coiled tube 1, and a second end opposite to the first end of the first retaining ring 31 is clamped with the first mounting cover 33. The first mounting base 32 is clamped with a bottom of the first mounting cover 33, and the locking mechanism 7 is disposed inside the first mounting cover 33.

As shown in FIGS. 2. and 4-6, the second mechanism 4 includes a second retaining ring 41, a second mounting base 42, and a second mounting cover 43. A second mounting hole 20 is disposed on the second mounting base 42. A first end of the second retaining ring 41 is clamped with the second end opposite to the first end of the coiled tube 1, and a second end opposite to the first end of the second retaining ring 41 is clamped with the second mounting cover 43. The second mounting base 42 is clamped with a bottom of the second mounting cover 43, and the second end opposite to the first end of the elastic component 6 is fixedly connected with the second mounting cover 43.

When the child safety door barrier needs to be installed, positions where the first mounting hole 19 disposed on the first mounting base 32 and the second mounting hole 20 disposed on the second mounting base 42 are installed should be ma ked first, then based on materials which build the installation positions such as cement, masonry, wood or other different materials, suitable screw fittings are selected to fix the child safety door barrier.

As shown in FIG. 2, the present disclosure further comprises a support rod 17, a first end of the support rod 17 is connected with the first mounting cover 33, and a second end opposite to the first end of the support rod 17 is connected with the second mounting cover 43. Through providing the support rod 17, overall stability and safety of the child safety door barrier are enhanced.

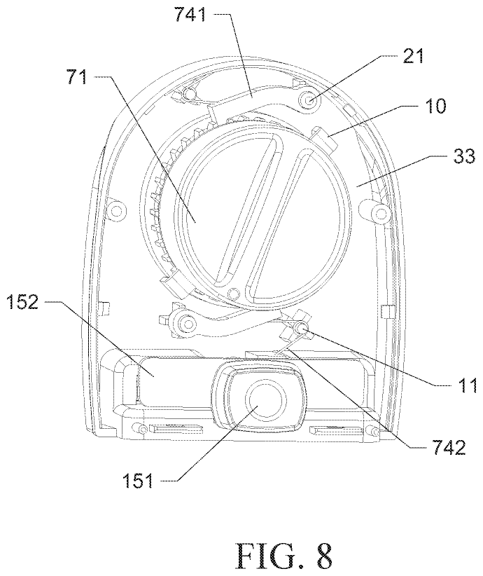

As shown in FIGS. 7-8, a separate assembly 15 is disposed inside the first mounting cover 33, and the separate assembly 15 is configured to separate the first mounting base 32 and the first mounting cover 33. The separate assembly 15 includes a key 151, a separate component 152, and a key spring 153. The key 151 is clamped with the separate component 152. A first end of the key spring 153 is connected with the first mounting base 32, and a second end opposite to the first end of the key spring 153 is connected with the separate component 152. A push block 16 is disposed on the separate component 152. When the key spring 153 is in an original state, the push block 16 is separated from the first mounting base 32, and the first mounting base 32 is clamped with the first mounting cover 33. When the key spring 153 is in a pressed state, the push block 16 is clamped with the first mounting base 32, and the first mounting base 32 is separated from the first mounting cover 33.

When the child safety door barrier needs to be taken out, the key 151 is pressed and drives the separate component 152 to press the key spring 153, the key spring 153 is deformed under pressure, and the push block 16, driven by pressure, moves along a direction of the first mounting base 32 to be clamped with the first mounting base 32. At this time, the first mounting base 32 is separated from the first mounting cover 33, then the entire child safety door barrier is taken upwards, and the child safety door barrier is taken out from the first mounting base 32 and the second mounting base 42. When the key 151 is released, the key spring 153 jacks up the key 151 and the separate component 152 under reaction force, so that the key 151 and the separate component 152 automatically return back.

As shown in FIGS. 7-8, the locking mechanism 7 includes a knob 71, a gear 72, a rotating spring 73, and a locking assembly 74. The locking assembly 74 is disposed inside the first mounting cover 33. A gear groove 9 is disposed on the first end of the coiled tube 1. The gear 72 is clamped inside the gear groove 9. A first end of the rotating spring 73 is connected with an axis of the gear 72, and a second end opposite to the first end of the rotating spring 73 is connected with the knob 71. A bump 10 is disposed on the knob 71. When the coiled tube 1 is locked, the pump 10 is separated from the locking assembly 74, and the locking assembly 74 is clamped with gear teeth of the gear 72. When the coiled tube 1 is unlocked, the bump 10 is clamped with locking assembly 74, and the locking assembly 74 is separated from the gear teeth of the gear 72.

After the child safety door barrier is fixed, the coiled tube 1 is in a result state, and the bump 10 disposed on the knob 71 is clamped with the locking assembly 74. At this time, the locking assembly 74 does not limit the gear 72 and the coiled tube 1. The coiled tube 1 rotates relative to the first mounting base 32 and the second mounting base 42, the fabric 2 wound around the coiled tube 1 is pulled out to a designated position through the transceiving mechanism 8 and fixed. At this time, through rotating the knob 71, the locking assembly 74 is switched from an unlocked state to a locked state, the bump 10 disposed on the knob 71 is separated from the locking assembly 74, the locking assembly 74 is clamped with the gear teeth of the gear 72 to limit rotation of the gear 72 and the rotation of the coiled tube 1, so that the rotation of the fabric 2 is limited and the fabric 2 cannot be contracted. Thus, the child safety door barrier plays the role in shielding and isolating, and a protection effect is achieved.

As shown in FIGS. 7-8, the locking assembly 74 includes at least one locking block 741 and at least one stop spring 742. At least one first fixing column 11 and at least one second fixing column 21 are disposed inside the first mounting cover 33. The stop spring 742 is fixed on the first fixing column 11. A first end of the locking block 741 is fixed on the second fixing column 21. A first end of the stop spring 742 is connected with the first mounting cover 33. A second end opposite to the first end of the stop spring 742 is connected with a second end opposite to the first end of the locking block 741. When the coiled tube 1 is locked, the pump 10 is separated from the locking block 741, and the locking block 741 is clamped with the gear teeth of the gear 72, When the coiled tube 1 is unlocked, the bump 10 is clamped with locking block 741, and the locking block 741 is separated from the gear teeth of the gear 72, so that the locking block 741 does not further limit the gear 72 and the coiled tube 1,

Elasticity of the elastic component 6 is much greater than elasticity of the stop spring 742. A shape of the gear groove 9 determines that when the locking block 741 is engaged with the gear teeth of the gear 72, the locking block 741 only clamps the gear 72 in one direction. Since the elasticity of the elastic component 6 is much greater than the elasticity of the stop spring 742, rotation force of the elastic component 6 drives the stop spring 742 to force the locking block 741 to reciprocate at the gear teeth of the gear 72, but the rotation force of the elastic component 6 limits the coiled tube 1 rotate in a clockwise direction, limiting the coiled tube 1 to rotate in the clockwise direction means that the fabric 2 is limited to pull outwards.

There are two first fixing columns 11, two second fixing columns 21, two stop springs 742, and two locking block 741 disposed on the child safety door barrier, which further improves a locking function of the locking assembly 74.

As shown in FIG. 7, the locking mechanism 7 further includes a knob cover 75. The knob cover 75 is clamped with the first mounting cover 33. A through hole 22 is disposed on the knob cover 75. The knob 71 is disposed inside the through hole 22. A mark 12 is disposed on the knob cover 75, and the mark 12 is configured to show whether the knob 75 is locked or unlocked.

The knob cover 75 separates components such as the first fixing column 11, the second fixing column 21, the stop spring 742, and the locking block 741 in the first mounting cover 33, which not only plays a role in protecting, but also prevents hands of the children from putting into the first mounting cover 33, the safety performance is higher. The mark 12 disposed on the knob cover 75 is convenient for adults to intuitively know that the coiled tube 1 is in the locked state or the unlocked state, which makes an operation process more convenient.

As shown in FIG. 1, the transceiving mechanism 8 includes a handle rod 81, a first transceiving component 82, and a second transceiving component 83. The handle rod 81 is disposed on the second end opposite to the first end of the fabric 2. The first transceiving component 82 is disposed a first end of the handle rod 81, and the second transceiving component 83 is disposed on a second end opposite to the first end of the handle rod 81.

As shown in FIG. 1, the first transceiving component 82 includes a first hook base 821 and a first handle hook 822. The first handle hook 822 is disposed on the first end of the handle rod 81. A first limiting block 23 is disposed on the first hook base 821, and the first limiting block 23 is configured to clamp with the first handle hook 822. A first fixing hole 13 is disposed on the first hook base 821.

As shown in FIG. 1, the second transceiving component 83 includes a second hook base 831 and a second handle hook 832. The second handle hook 832 is disposed on the second end opposite to the first end of the handle rod 81. A second limiting block 24 is disposed on the second hook base 831, and the second limiting block 24 is configured to clamp with the second handle hook 832. A second fixing hole 14 is disposed on the second hook base 831.

In actual use, positions of the first fixing hole 13 disposed on the first hook base 821 and the second fixing hole 14 disposed on the second hook base 831 should be marked first, then based on materials which build the positions such as cement, masonry, wood or other different materials, suitable screw fittings are selected to fix the child safety door barrier. The first hook base 821 is configured to fix the first handle hook 822, the second hook base 831 is configured to fix the second handle hook 832, and after the fabric 2 is pulled out, the first handle hook 822 disposed on the first end of the handle rod 81 is hooked on the first hook base 821, and the second handle hook 832 disposed on the second end of the handle rod 81 is hooked on the second hook base 831, so that the fabric 2 keeps in an unfolded state to play a role in shielding and isolating.

As shown in FIG. 1, an opening 18 is disposed on a connection of the handle rod 81 and the fabric 2, The opening 18 is disposed on a middle position of the fabric 2. When the child safety door barrier needs to be closed, the locking assembly 74 is switched from the unlocked state to the locked state. Through disposing the opening 18, the handle rod 81 is pulled by one hand to take the first handle hook 822 and the second handle hook 832 out of the first hook base 821 and the second hook base 831, this operation is convenient for a user holding a child or holding an object.

The child safety door barrier of the present disclosure is installed at positions such as where the door, the passage, and the stair opening at in the houses, which limits the activity range of the children and is also convenient for the adults to open or close.

The foregoing is only the preferred embodiments of the present disclosure, and protection scopes of the present disclosure are not limited to the embodiments mentioned above. All technical solutions under the idea of the present disclosure belong to the protection scopes of the present disclosure. For those skilled in the art, several improvements and modifications made without departing from the principles of the present disclosure should also be regarded as the protection scopes of the present disclosure.

What is claimed is:

1. A child safety door barrier, comprising:
a coiled tube;
a fabric wound around the coiled tube;
wherein a first mounting mechanism is disposed on a first end of the coiled tube; a second mounting mechanism is disposed on a second end opposite to the first end of the coiled tube; a circular groove is disposed inside the coiled tube; an elastic component is disposed inside the circular groove; a first end of the elastic component penetrates through the coiled tube and then fixedly connects with a first end of the fabric; a second end opposite to the first end of the elastic component is fixedly connected with the second mounting mechanism; a transceiving mechanism is disposed on a second end opposite to the first end of the fabric, and the transceiving mechanism is configured to pull the fabric out from the coiled tube and fix the fabric; and
a locking mechanism is disposed inside the first mounting mechanism, the locking mechanism is configured to lock or unlock the coiled tube, and the locking mechanism is connected with the coiled tube.

2. The child safety door barrier according to claim 1, wherein the first mounting mechanism comprises a first retaining ring, a first mounting base, and a first mounting cover; a first mounting hole is disposed on the first mounting base; a first end of the first retaining ring is clamped with the first end of the coiled tube, and a second end opposite to the first end of the first retaining ring is clamped with the first mounting cover; the first mounting base is clamped with a bottom of the first mounting cover; and the locking mechanism is disposed inside the first mounting cover.

3. The child safety door barrier according to claim 2, wherein the locking mechanism comprises a knob, a gear, a rotating spring, and a locking assembly; the locking assembly is disposed inside the first mounting cover; a gear groove is disposed on the first end of the coiled tube; the gear is clamped inside the gear groove; a first end of the rotating spring is connected with an axis of the gear, and a second end opposite to the first end of the rotating spring is connected with the knob; a bump is disposed on the knob; and
when the coiled tube is locked, the pump is separated from the locking assembly, and the locking assembly is clamped with gear teeth of the gear; when the coiled tube is unlocked, the bump is clamped with locking assembly, and the locking assembly is separated from the gear teeth of the gear.

4. The child safety door barrier according to claim 3, wherein the locking assembly comprises at least one locking block and at least one stop spring; at least one first fixing column and at least one second fixing column are disposed inside the first mounting cover; the stop spring is fixed on the first fixing column; a first end of the locking block is fixed on the second fixing column; a first end of the stop spring is connected with the first mounting cover; a second end opposite to the first end of the stop spring is connected with a second end opposite to the first end of the locking block; and
when the coiled tube is locked, the pump is separated from the locking block, and the locking block is clamped with the gear teeth of the gear; when the coiled tube is unlocked, the bump is clamped with locking block, and the locking block is separated from the gear teeth of the gear.

5. The child safety door barrier according to claim 3, wherein the locking mechanism further comprises a knob cover; the knob cover is clamped with the first mounting cover; a through hole is disposed on the knob cover; the knob is disposed inside the through hole; and a mark is disposed on the knob cover, the mark is configured to show whether the knob is locked or unlocked,

6. The child safety door barrier according to claim 1, wherein the second mechanism comprises a second retaining ring, a second mounting base, and a second mounting cover; a second mounting hole is disposed on the second mounting base; a first end of the second retaining ring is clamped with the second end opposite to the first end of the coiled tube, and a second end opposite to the first end of the second retaining ring is clamped with the second mounting cover; the second mounting base is clamped with a bottom of the second mounting cover; and the second end opposite to the first end of the elastic component is fixedly connected with the second mounting cover.

7. The child safety door barrier according to claim 1, wherein the transceiving mechanism comprises a handle rod, a first transceiving component, and a second transceiving component; the handle rod is disposed on the second end opposite to the first end of the fabric; the first transceiving component is disposed a first end of the handle rod; and the second transceiving component is disposed on a second end opposite to the first end of the handle rod.

8. The child safety door barrier according to claim 7, wherein the first transceiving component comprises a first hook base and a first handle hook; the first handle hook is disposed on the first end of the handle rod; a first limiting block is disposed on the first hook base, and the first limiting block is configured to clamp with the first handle hook; and a first fixing hole is disposed on the first hook base.

9. The child safety door barrier according to claim 7, wherein the second transceiving component comprises a second hook base and a second handle hook; the second handle hook is disposed on the second end opposite to the first end of the handle rod; a second limiting block is disposed on the second hook base, and the second limiting block is configured to clamp with the second handle hook; and a second fixing hole is disposed on the second hook base.

10. The child safety door barrier according to claim 2, wherein a separate assembly is disposed inside the first mounting cover, and the separate assembly is configured to separate the first mounting base and the first mounting cover; the separate assembly comprises a key, a separate component, and a key spring; the key is clamped with the separate component; a first end of the key spring is connected with the first mounting base, and a second end opposite to the first end of the key spring is connected with the separate component; a push block is disposed on the separate component; and
when the key spring is in an original state, the push block is separated from the first mounting base, and the first mounting base is clamped with the first mounting cover; when the key spring is in a pressed state, the push block is clamped with the first mounting base, and the first mounting base is separated from the first mounting Cover.
